(19) United States
(12) Patent Application Publication
(10) Pub. No.: US 2016/0294169 A1
(43) Pub. Date: Oct. 6, 2016

(54) CABLE KNIFE HAVING TWO BLADES

(71) Applicant: KRAMPE Immobilien GmbH & Co. KG, Ascheberg (DE)

(72) Inventor: Carsten BUENNIGMANN, Ascheberg - Herbern (DE)

(73) Assignee: KRAMPE Immobilien GmbH & Co. KG, Ascheberg (DE)

(21) Appl. No.: 15/075,283

(22) Filed: Mar. 21, 2016

(30) Foreign Application Priority Data
Mar. 30, 2015 (DE) 10 2015 104 906.6

(51) Int. Cl. H02G 1/12

(52) U.S. Cl. CPC H02G 1/1212; H02G 1/1219

(57) ABSTRACT

A cable knife has a housing as a handle and a slitting blade that projects out at a face side of the housing, above which blade a triangularly bent clamping bracket that is displaceably affixed to the housing is disposed in such a manner that it presses a cable laid in under the clamping bracket onto the slitting blade, and in which knife an additional hooked blade is attached to the housing, wherein the hooked blade is attached to the housing in fixed manner and is protected with a blade guard, and the clamping bracket is held in the housing in replaceable manner, by an engagement tongue.

### CROSS REFERENCE TO RELATED APPLICATIONS

Applicant claims priority under 35 U.S.C. §119 of German Application No. 10 2015 104 906.6 filed Mar. 30, 2015, the disclosure of which is incorporated by reference.

### BACKGROUND OF THE INVENTION

1. Field of the Invention

The invention relates to a cable knife having a housing as a handle and a slitting blade that projects out at the face side of the housing, above which blade a triangularly bent clamping bracket that is displaceably affixed to the housing is disposed so that it presses a cable laid in under the clamping bracket onto the slitting blade, and in which knife an additional hooked blade is attached to the housing.

2. Description of the Related Art

Cable knives are used for removing the cable sheath of a cable end. For this purpose, a slitting blade is provided, with which a longitudinal cut and/or round cut can be made in the cable sheath. Afterward the cable sheath at the cable end can easily be removed. In order for the slitting blade to be reliably guided in the cable sheath, a spring-loaded, triangular-shaped clamping bracket is provided, which surrounds the cable end and presses it onto the slitting blade.

In order to be able to slit cables having different sheath thicknesses, adjustability of the slitting blade is typically provided. The clamping bracket is dimensioned for a range of cable diameters. For deviating cable diameters, cable knives having larger or smaller clamping brackets must be kept on hand.

Furthermore, a hooked blade is often helpful when removing the cable sheath, particularly if the cable sheath is thicker or quite stiff. The hooked blade is set onto the cable sheath, at the cable end, so that the hook engages under the cable sheath, and now a longitudinal cut is made in the cable sheath, by pulling the hooked blade.

A cable knife of the type stated is described in the European patent application EP 1 887 669 B1. The cable sheath removal tool described there has the slitting blade, a spring-loaded clamping bracket, and also a hooked blade. The clamping bracket predetermines the range for the diameters of the cables to be processed, with the size of its V-shaped end and the width of its ability to be pushed out of the housing. Replaceability of the clamping brackets is not provided. The hooked blade is displaceably mounted in the housing and is pushed out of the housing when needed. Because of the displaceable mounting, the hooked blade does not have a firm seat on the housing, and this impairs the guidance of the hooked blade while cutting the cable sheath, and increases the risk of injury.

### SUMMARY OF THE INVENTION

It is the task of the invention to disclose a cable knife that can be adapted to different diameters of cables to be processed, and in which reliable guidance of the hooked blade is guaranteed.

This task is accomplished by means of a cable knife according to the invention. Advantageous embodiments are indicated below.

The cable knife possesses a housing as a handle and a slitting blade that projects out of a face side of the housing. A displaceably affixed, triangularly bent clamping bracket is disposed on the housing, above the face side, so that it presses a cable that has been laid in under the clamping bracket onto the slitting blade. Furthermore, an additional hooked blade is attached to the housing.

The cable knife is characterized in that the hooked blade is attached to the housing in fixed manner and is protected with a blade guard, and that the clamping bracket is held in the housing in replaceable manner, by means of an engagement tongue.

A reliable cut can be carried out by means of the fixed, hooked blade on the housing.

For adaptation to large ranges of cable cross-sections, different clamping brackets are provided for different ranges of cable diameters.

The replaceable clamping bracket allows simple changing of the clamping bracket during installation work on site. Therefore, only clamping brackets of different sizes have to be kept on hand, not different cable knives.

The slit depth is set by way of the projection of the slitting blade from the housing. This setting can easily take place by way of a screw adjustment.

For processing of the cable ends, a matching clamping bracket is pushed into a passage in the housing with its post, in each instance, and held with the engagement tongue, on a spring-loaded carriage, in a recess in the post. The engagement tongue can easily be pressed back through an opening in the housing.

It is advantageous if the opening in the housing is selected in such a manner that a post end of the clamping bracket can be fitted in there and, by way of the bracket, the engagement tongue ears be pressed back so far that the clamping bracket situated in the housing can be pulled out.

It is advantageous if the hooked blade is affixed on the face side of the housing that lies opposite the clamping bracket. In this way, the clamping bracket is not in the way when work is performed with the hooked blade.

When not in use, the hooked blade is covered by the displaceable blade guard, so that no risk of injury exists. When the hooked blade is in use, the blade guard is pushed back into the housing, and the hooked blade is released.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a top view of an embodiment of a cable knife according to the invention with relaxed clamping bracket and covered hooked blade;

FIG. 2 is a side view according to FIG. 1;

FIG. 3 is a top view with tensioned clamping bracket and free hooked blade;

FIG. 4 is a side view according to FIG. 3.

### DETAILED DESCRIPTION OF PREFERRED EMBODIMENTS

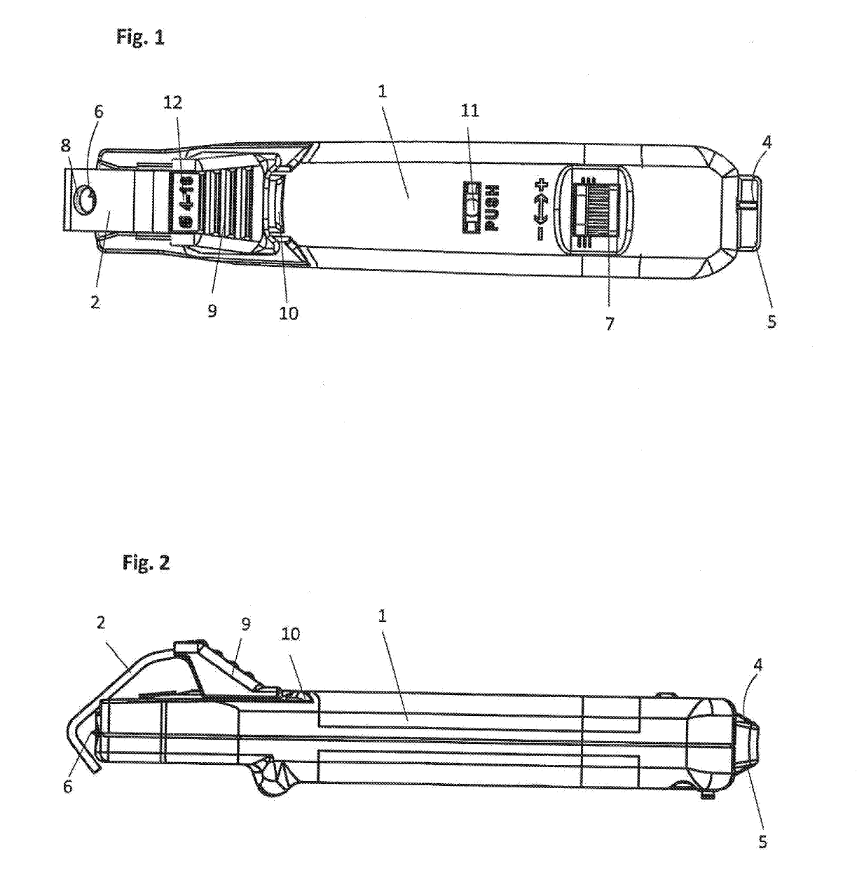

In FIG. 1 and FIG. 2, the cable knife is shown in a top view and side view, with its housing 1 and its retracted clamping bracket 2. The slitting blade 6 on the one face side of the housing 1 can just be seen through the viewing hole 8. The cutting depth of the slitting blade 6 can be adjusted by way of the adjustment wheel 7 for the slitting blade.

The clamping bracket 2 is inserted into the insertion slot 10 of the housing 1, and can be released by way of the opening 11. The thumb plate 9 allows advancing of the clamping bracket 2. The range indicator 12 characterizes the clamping bracket inserted at the time.

The hooked blade 4 is situated on the opposite face side of the housing 1 and is covered by the blade guard 5.

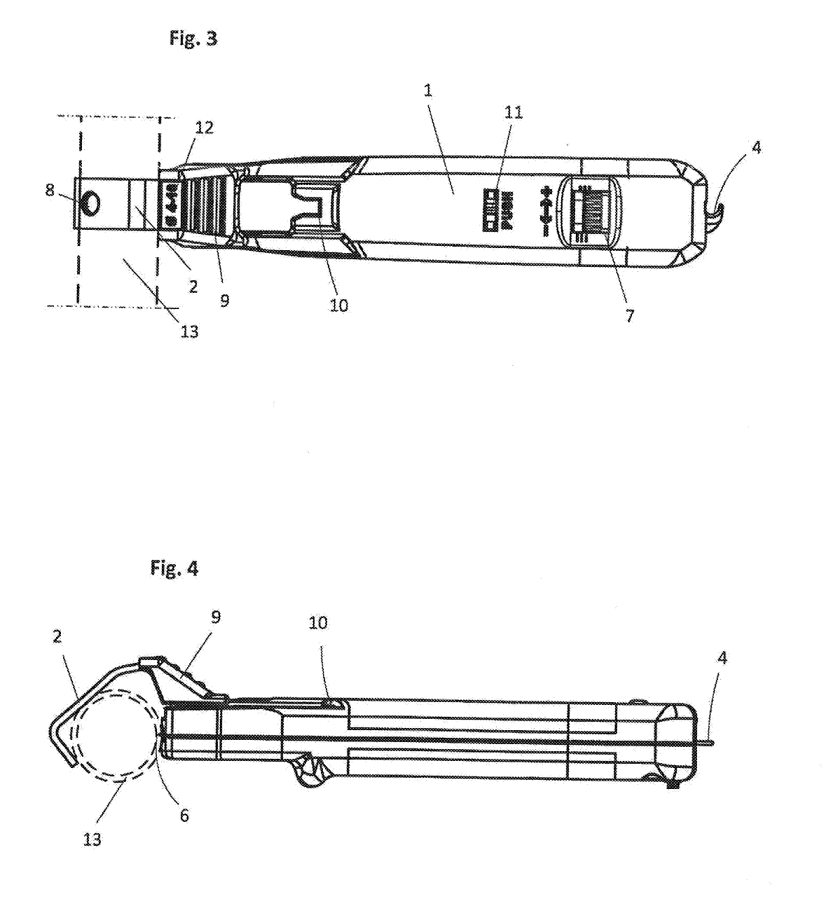

In FIG. 3 and FIG. 4, the cable knife is shown in a top view and side view, with a cable clamped in under the clamping bracket 2, which has been pressed out. The slitting blade 6 on the one face side of the housing 1 penetrates into the cable sheath 13. The cutting depth of the slitting blade 6 into the cable sheath 13 is adjustable by way of the adjustment wheel 7.

The clamping bracket 2 is guided in the insertion slot 10 of the housing 1, and can be advanced using the thumb plate 9.

The clamping bracket 2 can be released by way of the opening 11. The range indication 12 characterizes the clamping bracket that is inserted at the time.

The hooked blade 4 is situated at the opposite face side of the housing 1. The blade guard is pushed in and therefore cannot be seen.

Although only a few embodiments of the present invention have been shown and described, it is to be understood that many changes and modifications may be made thereunto without departing from the spirit and scope of the invention.

What is claimed is:

1. A cable knife comprising:
(a) a housing forming a handle and having a face side;
(b) a slitting blade projecting out at the face side of the housing;
(c) an engagement tongue;
(d) a triangularly bent clamping bracket displaceably affixed to the housing and held in the housing in replaceable manner by the engagement tongue, said clamping bracket being disposed above the slitting blade so as to press a cable laid in under the clamping bracket onto the slitting blade;
(e) a hooked blade attached to the housing in a fixed manner; and
(f) a blade guide protecting the hooked blade.

2. The cable knife according to claim 1, wherein the housing is configured to receive different clamping brackets for different ranges of cable diameters.

3. The cable knife according to claim 1, further comprising a spring-loaded carriage comprising the engagement tongue, wherein the damping bracket comprises a post having a recess, and wherein the clamping bracket is pushed into a passage in the housing with the post, and held with the engagement tongue of the spring-loaded carriage, in the recess in the post.

4. The cable knife according to claim 3, wherein the engagement tongue is pressable back through an opening in the housing.

5. The cable knife according to claim 1, wherein the face side of the housing lies opposite to the clamping bracket and the hooked blade is affixed on the face side of the housing that lies opposite the clamping bracket.

6. The cable knife according to claim 5, wherein the blade guard is displaceable into the housing.

7. The cable knife according to claim 1, wherein the slitting blade is configured to project out of the housing by an adjustable distance.
